(19) United States
(12) Patent Application Publication
(10) Pub. No.: US 2016/0055297 A1
(43) Pub. Date: Feb. 25, 2016

(54) METHOD FOR EXTRACTING BIOMARKER FOR DIAGNOSING PANCREATIC CANCER, COMPUTING DEVICE THEREFOR, BIOMARKER FOR DIAGNOSING PANCREATIC CANCER AND DEVICE FOR DIAGNOSING PANCREATIC CANCER INCLUDING THE SAME

(71) Applicants: LG ELECTRONICS INC., Seoul (KR); INDUSTRY-ACADEMIC COOPERATION FOUNDATION, YONSEI UNIVERSITY, Seoul (KR)

(72) Inventors: Hyungseok CHOI, Seoul (KR); Jeeyeon HEO, Seoul (KR); Yongjin CHOI, Seoul (KR); Haeseok EO, Seoul (KR); Siyoung SONG, Seoul (KR); Dawoon JUNG, Seoul (KR)

(73) Assignees: LG ELECTRONICS INC., Seoul (KR); Industry-Academic Cooperation Foundation, Yonsei University, Seoul (KR)

(21) Appl. No.: 14/784,550

(22) PCT Filed: Apr. 16, 2014
(86) PCT No.: PCT/KR2014/003300

§ 371 Date: Oct. 14, 2015

(30) Foreign Application Priority Data
Apr. 17, 2013 (KR) 10-2013-0042329
Oct. 15, 2013 (KR) 10-2013-0122634

(51) Int. Cl. G06F 19/24; C40B 30/02

(52) U.S. Cl. CPC G06F 19/24; C40B 30/02

(57) ABSTRACT

Disclosed are a method for extracting a biomarker for diagnosing pancreatic cancer, a computing device therefor, a biomarker for diagnosing pancreatic cancer and a device for diagnosing pancreatic cancer including the same. More particularly, disclosed are a method for extracting a biomarker for diagnosing pancreatic cancer using genes specifically expressed in pancreatic cancer patients or microRNAs obtained from blood or tissues paired with the genes, a computing device therefor, a biomarker for diagnosing pancreatic cancer and a device for diagnosing pancreatic cancer including the same.

### TECHNICAL FIELD

The present invention relates to a method for extracting a biomarker for diagnosing pancreatic cancer, a computing device therefor, a biomarker for diagnosing pancreatic cancer and a device for diagnosing pancreatic cancer including the same, and more particularly, to a method for extracting a biomarker for diagnosing pancreatic cancer using microRNAs obtained from blood or tissues, a computing device therefor, a biomarker for diagnosing pancreatic cancer and a device for diagnosing pancreatic cancer including the same.

### BACKGROUND ART

The pancreas is an organ which has an external secretion function of secreting digestive enzymes degrading carbohydrates, fats and proteins of ingested foods and an internal secretion function of secreting hormones such as insulin and glucagon.

Pancreatic cancer is a tumor mass composed of cancer cells generated in the pancreas, which generally refers to pancreatic ductal adenocarcinoma and includes cystadenocarcinomas of the pancreas, endocrine tumors and the like. Pancreatic cancer has no specific early symptoms and early detection thereof is thus difficult.

The pancreas has a small thickness of about 2 cm, is surrounded with only a thin membrane and closely contacts the superior mesenteric artery which supplies oxygen to the small intestine and the portal vein which transports nutrients absorbed by the intestine to the liver, thus being readily invaded by cancers. In addition, early metastasis may occur on the nerve bundle and lymph gland of the rear of the pancreas. In particular, pancreatic cancer cells are rapidly grown. In most cases, pancreatic cancer patients can survive only 4 months to 8 months after onset. The prognosis is not good and survival of 5 years or longer is low, i.e., about 17 to 24%, even when surgery is generally successful and symptoms are alleviated.

Diagnosis of pancreatic cancer may be performed by ultrasonography, computed tomography (CT), magnetic resonance imaging (MRI), endoscopic retrograde cholangiopancreatography (ERCP), endoscopic ultrasound (EUS), proton emission tomography (PET) and the like. However, these imaging diagnosis methods entail high cost for diagnosis, are complicated and are not useful for early diagnosis. Accordingly, there is a demand for methods which are simple, entail a low cost and enable early diagnosis.

In this regard, several tens of biomarkers associated with other carcinomas have been reported over the last 20 years and protein biomarkers, CA19-9, CEA and the like are known as biomarkers for pancreatic cancers. However, these protein biomarkers have considerably low practical applicability to diagnosis due to low sensitivity and specificity of about 60%. In particular, blood groups that lack tissue specificity and do not express Lewis antigens have a problem of no increase in CA19-9. Accordingly, there is an increasing need for development of biomarkers which enable reliable diagnosis owing to high sensitivity and specificity.

Meanwhile, a microRNA (miRNA) refers to a short single strand of non-coding RNA molecule composed of about 17 to 25 nucleotides. microRNAs are known to control expression of protein-producing genes by blocking transcription of a target mRNA (gene) or degrading mRNAs. microRNAs are known to be present in the blood as well as tissues.

In addition, there is a need for development of biomarkers using tissue or blood samples for easy management and diagnosis. In particular, blood samples are advantageous.

### DISCLOSURE

### Technical Problem

An object of the present invention devised to solve the problem lies on providing a method for extracting a biomarker for diagnosing pancreatic cancer including a combination of genes specific to pancreatic cancer patients, or a method for extracting a biomarker for diagnosing pancreatic cancer using microRNAs obtained from blood or tissues, and a computing device therefor.

Another object of the present invention devised to solve the problem lies on providing a biomarker for diagnosing pancreatic cancer and a device for diagnosing pancreatic cancer including the same.

It will be appreciated by persons skilled in the art that the objects that can be achieved with the present invention are not limited to what has been particularly described hereinabove and the above and other objects that the present invention can achieve will be more clearly understood from the following detailed description.

### Technical Solution

The object of the present invention can be achieved by providing a method for extracting a biomarker for diagnosing pancreatic cancer including calculating interaction scores numerically expressing complementary binding capacity between microRNAs and genes, determining n microRNA-gene pairs, each having a higher interaction score among the interaction scores, and extracting microRNA paired with a gene specifically expressed in a pancreatic cancer patient from the n microRNA-gene pairs.

In another aspect of the present invention, provided herein is a biomarker for diagnosing pancreatic cancer including ANO1, C19orf33, EIF4E2, FAM108C1, IL1B, ITGA2, KLF5, LAMB3, MLPH, MMP11, MSLN, SFN, SOX4, TMPRSS4, TRIM29 and TSPAN1.

In another aspect of the present invention, provided herein is a biomarker for diagnosing pancreatic cancer using tissue as a biological sample, the biomarker including hsa-let-7g-3p, hsa-miR-7-2-3p, hsa-miR-23a-5p, hsa-miR-27a-5p, hsa-miR-92a-1-5p, hsa-miR-92a-2-5p, hsa-miR-122-5p, hsa-miR-154-3p, hsa-miR-183-5p, hsa-miR-204-5 p, hsa-miR-208b-3p, hsa-miR-425-5p, hsa-miR-510-5p, hsa-miR-520a-5p, hsa-miR-552-3p, hsa-miR-553, hsa-miR-557, hsa-miR-608, hsa-miR-611, hsa-miR-612, hsa-miR-671-5p, hsa-miR-1200, hsa-miR-1275, hsa-miR-1276, and hsa-miR-1287-5p.

In another aspect of the present invention, provided herein is a biomarker for diagnosing pancreatic cancer using blood as a biological sample, the biomarker including hsa-miR-27a-5p, hsa-miR-183-5p, and hsa-miR-425-5p.

In a further aspect of the present invention, provided herein is a device for diagnosing pancreatic cancer including any one of the biomarkers as described above.

It will be appreciated by persons skilled in the art that the aspects suggested by the present invention are not limited to what has been particularly described hereinabove and other aspects not described herein will be more clearly understood from the following detailed description.

### Advantageous Effects

The present invention provides a method for extracting biomarkers for diagnosing pancreatic cancer. The present invention provides a biomarker with high specificity and sensitivity for diagnosing pancreatic cancer. In addition, the present invention provides a device for diagnosing pancreatic cancer including the biomarker.

It will be appreciated by persons skilled in the art that the effects that can be achieved with the present invention are not limited to what has been particularly described hereinabove and other effects not described herein will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a block diagram illustrating a computing device according to the present invention;

FIG. 2 is a conceptual view illustrating an example of calculation of an interaction score between miRNA and a gene;

FIG. 3 is a flowchart illustrating a method for calculating the interaction score;

FIG. 4 is a conceptual view illustrating a method for calculating a correlation coefficient between similar miRNA and a specific gene using a similarity database;

FIG. 5 is a flowchart illustrating the calculation method of the correlation coefficient between similar miRNA and the specific gene using the similarity database;

FIG. 6 is a conceptual view illustrating a method for calculating a correlation coefficient between adjacent miRNA and a specific gene using a miRNA cluster database;

FIG. 7 is a flowchart illustrating a method for calculating a weight between the adjacent miRNA and the specific gene using the miRNA cluster database;

FIG. 8 is a conceptual view illustrating a method for calculating a correlation coefficient between specific miRNA and a transcription-regulating gene using a transcription factor database;

FIG. 9 is a flowchart illustrating the calculation method of the weight between specific miRNA and the transcription-regulating gene using the transcription factor database;

FIG. 10 is a flowchart illustrating a method for extracting a biomarker for diagnosing pancreatic cancer based on integrated analysis algorithm for biomarker extraction;

FIGS. 11 and 12 are a cluster plot showing results of principal component analysis using data GSE28735 and a heat map showing results of hierarchical clustering analysis using data GSE28735, respectively;

FIGS. 13 and 14 are a cluster plot showing results of principal component analysis using data GSE15471 and a heat map showing results of hierarchical clustering analysis using data GSE15471, respectively;

FIG. 15 is a view illustrating results of hierarchical clustering analysis using GEO data GSE32678;

FIG. 16 is a view illustrating results of hierarchical clustering analysis using a next generation sequencing data; and

FIG. 17 is a conceptual view illustrating small RNA sequencing data analysis as a specific example of next generation sequencing (NGS).

### BEST MODE

Reference will now be made in detail to the preferred embodiments of the present invention, examples of which are illustrated in the accompanying drawings.

Hereinafter, the computing device related to the present invention will be described in more detail with reference to the drawings.

The terms “module” and “unit”, appended to elements in the following description, are given or used in combination only for ease of description of specification and do not have any particular meaning or function to distinguish the terms from each other.

The present invention discloses a biomarker computing device 100 using an integrated analysis algorithm for extracting biomarkers and a biomarker extracted through the computing device 100. The computing device 100 described herein may include a high-speed computing device using an electric circuit, such as a personal computer, a workstation and a supercomputer. The computing device may include, in addition to a stationary device such as a computer, a workstation and a supercomputer, a mobile device such as a smart phone, a PDA and a laptop which include a central processing unit and perform calculation processing.

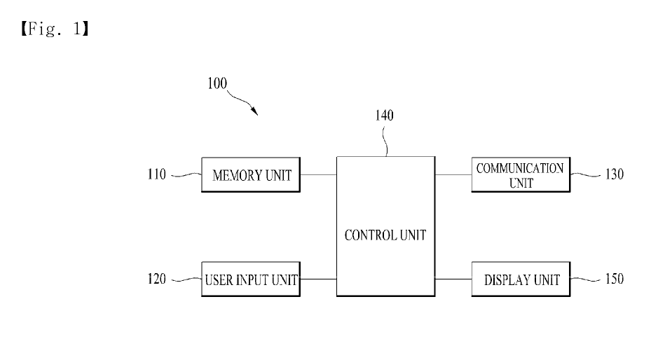

FIG. 1 is a block diagram illustrating a computing device according to the present invention. Referring to FIG. 1, the computing device 100 according to the present invention may include a memory unit 110, a user input unit 120, a communication unit 130 and a control unit 140.

The memory unit 110 stores programs for operation of the control unit 140 and temporarily stores input and output data (for example, database). Furthermore, the memory unit 110 may store transmitted or received data upon communication by the communication unit 130.

The memory unit 110 may include at least one memory medium of a flash memory, a hard disk, a multimedia card micro-type memory, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disc, an optical disc and the like.

The user input unit 120 functions to receive a user input from a user. The user input unit 120 may include a keyboard, a mouse and the like.

The communication unit 130 functions to receive data from the outside or to transmit data to the outside for communication. The communication unit 130 according to the present invention may function to receive a variety of databases from a remote server.

The control unit 140 controls the overall operation of the computing device 100 and performs various calculations. The control unit 140 according to the present invention calculates interaction scores and correlation coefficients as described later and performs a calculation for extracting biomarkers for diagnosing pancreatic cancer.

The computing device 100 according to the present invention may further include a display unit 150 to output information. The display unit 150 functions to display a user input and as an output device for outputting a result of calculation of the control unit 140. The display unit 150 may be a device, such as a monitor, for assisting the computing device 100.

Configurations and methods of the embodiments described later may be limitedly applied to the computing device 100 described above and selective combination of the entirety or part of the respective embodiments may be applied thereto such that various modifications of the embodiments are possible.

The method for extracting a biomarker for diagnosing pancreatic cancer will be described in detail using the computing device 100.

An integrated analysis algorithm for extraction of biomarkers described herein includes a combination of a differentially-expressed gene analysis algorithm and a microRNA-targeting gene analysis algorithm.

First, the differentially-expressed gene algorithm will be described. The differentially-expressed gene algorithm aims at statistically significantly finding genes over-expressed or under-expressed in pancreatic cancer patients, unlike normal persons, thereby finding genes capable of distinguishing a normal person group from a patient group using a linear model which is an advanced statistical method considering various factors (Reference document: Statistical Applications in Genetics and Molecular Biology, Vol. 3, No. 1, Article 3).

The differentially-expressed gene analysis algorithm may be broadly divided into data normalization and statistical analysis. In the data normalization, microarray data of the entire human genome obtained from the normal person group and the patient group are integrated and corrected. For data normalization, a robust multichip average (RMA) algorithm may be used (Reference document: Biostatistics, Vol. 4, No. 2, 249-264).

In the statistical analysis, genes having statistically significant difference in the amount of expression between the groups (that is, normal person group and patient group) are selected based on normalized data using a linear model. Genes having a q-value (statistical significance probability), which is a p-value corrected using a false discovery rate (FDR) method described in Reference Document [(Journal of the Royal Statistical Society, Series B (Methodological), Vol. 57, No. 1, 289-300)], of 0.01 or less may be selected.

The computing device 100 according to the present invention may use a list of genes that are abnormally expressed (over-expressed or under-expressed) in pancreatic cancer patients using the differentially-expressed gene analysis algorithm for extraction of a biomarker for diagnosing pancreatic cancer. Finding the list of genes abnormally expressed in pancreatic cancer patients using the differentially-expressed gene analysis algorithm is well-known in the art and a detailed explanation thereof is thus omitted.

Next, the microRNA-targeting gene analysis algorithm will be described. The microRNA-targeting gene analysis algorithm described herein provides a statistical equation which can accurately find target genes of microRNAs using at least one of microRNA-targeting gene prediction scores obtained from conventional microRNA databases, correlation coefficients for expression patterns of between microRNAs and genes obtained by microarray testing, and weights calculated according to biological mechanisms.

Hereinafter, methods of calculating the microRNA-targeting gene prediction scores (or interaction scores), correlation coefficients and weights will be described in detail. For convenience of description, the expression “miRNA” as used herein means a microRNA.

Calculation of microRNA-Targeting Gene Prediction Score The computing device 100 according to the present invention may calculate interaction scores which numerically express levels of complementary binding between microRNAs and target genes thereof. The interaction scores suggest levels of potentiality of complementary binding between microRNAs and target genes thereof. A method for calculating the interaction scores will be described in more detail with reference to the drawings described later.

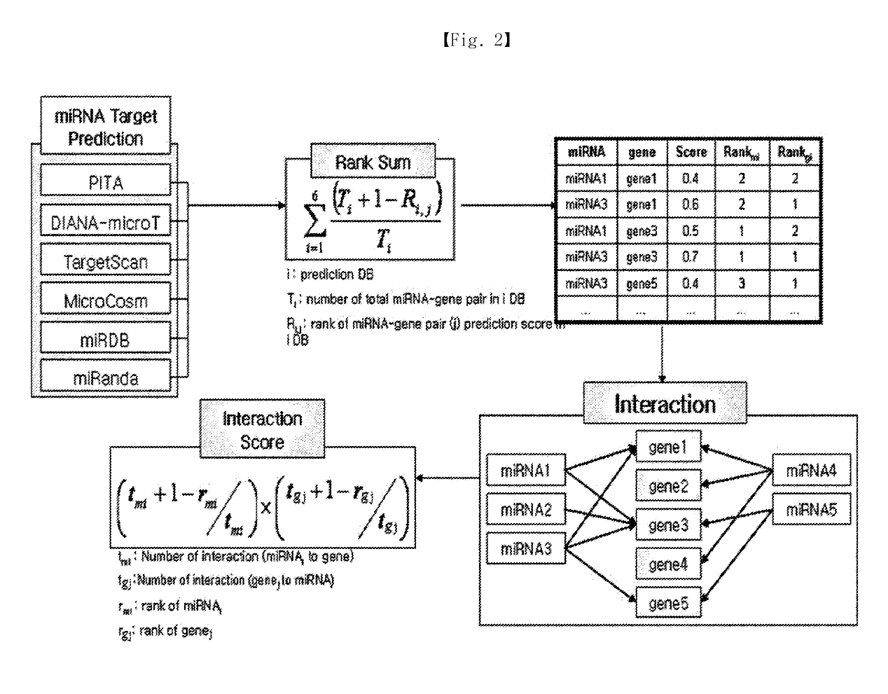

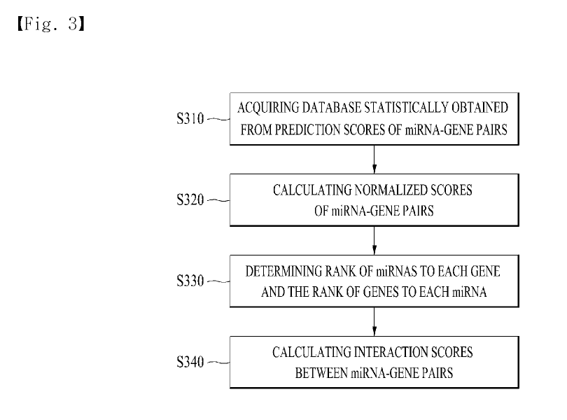

FIG. 2 is a conceptual view illustrating an example of calculation of interaction scores between miRNAs and genes. FIG. 3 is a flowchart illustrating a method for calculating the interaction scores.

Referring to FIGS. 2 and 3, first, the computing device 100 acquires databases statistically obtained from prediction scores between miRNAs and genes using at least one miRNA target prediction tool (S310).

The miRNA target prediction tool may be a software tool which numerically indicates levels of binding of pairs of target genes and miRNAs which complementary bind to the target genes and thereby inhibit synthesis of proteins from the target genes. The miRNA target prediction tool for acquiring the prediction scores of the gene-miRNA pairs includes Targetscan, miRDB, DIANA-microT, PITA, miRanda, MicroCosm, RNAhybrid, PicTar, RNA22 and the like. A brief explanation of respective miRNA target prediction tools is shown in Table 1 below.

TABLE 1

| | Explanation of tool (used | |
|---|---|---|
| Tool name | information) | Related sites |
| Targetscan | Sequence similarity information and | http://www.ncbi.nlm.nih.gov/pubmed/18955434 |
| | conservation information are used | |
| miRDB | Sequence similarity information, | http://www.ncbi.nlm.nih.gov/pubmed/18426918 |
| | thermodynamic stability information, | |
| | and conservation information are | |
| | used | |
| DIANA- | Sequence similarity information and | http://www.ncbi.nlm.nih.gov/pubmed/15131085 |
| microT | thermodynamic stability information | |
| | are used | |
| PITA | Sequence similarity information and | http://www.ncbi.nlm.nih.gov/pubmed/17893677 |
| | thermodynamic stability information | |
| | are used | |
| miRanda | Thermodynamic stability and | http://www.ncbi.nlm.nih.gov/pubmed/14709173 |
| | conservation information are used | |
| MicroCosm | Thermodynamic stability information | http://www.ebi.ac.uk/enright-srv/microcosm/htdocs/targets/v5/info.html |
| | and conservation information are | |
| | used | |
| RNAhybrid | Thermodynamic stability information | http://www.ncbi.nlm.nih.gov/pubmed/15383676 |
| | is used | |
| PicTar | Sequence similarity information and | http://www.ncbi.nlm.nih.gov/pubmed/15806104 |
| | conservation information are used | |
| RNA22 | Sequence pattern information is used | http://www.ncbi.nlm.nih.gov/pubmed/16990141 |

Prediction scores between miRNAs and genes that may complementarily bind thereto can be obtained using the target prediction tool. As prediction score decreases, complementary binding possibility between the miRNA and the gene decreases.

The target prediction tool may be driven by the computing device 100 according to the present invention and databases statistically obtained from prediction scores of miRNA-gene pairs may be acquired by calculation of the control unit 140, but the present invention is not limited thereto. The computing device 100 according to the present invention may acquire databases statistically obtained from prediction scores of miRNA-gene pairs from a remote server using the target prediction tool.

In order to increase reliability of prediction scores of miRNA-gene pairs, a plurality of databases are preferably acquired using a plurality of target prediction tools rather than one target prediction tool. FIG. 2 shows an example wherein PITA, DIANA-microT, TargetScan, MicroCosm, miRDB and miRanda are used as the target prediction tools.

In case of the acquisition of databases statistically obtained from prediction scores of miRNA-gene pairs using the target prediction tools, for normalization of the databases, the control unit 140 may calculate normalized scores, based on rank of the prediction scores of miRNA-gene pairs (S320).

As can be seen from the example shown in Table 1, information used for the miRNA target prediction tool may be different and units for scoring prediction scores may be different between the respective databases. For this reason, for use of a plurality of databases, normalization of the databases may be required. For normalization of prediction scores of miRNA-gene pairs, the control unit 140 determines a rank of the respective databases based on prediction scores of miRNA-gene pairs, converts the prediction scores into standard scores and sums the standard scores of miRNA-gene pairs in respective databases to acquire normalized scores. Equation 1 provides an example of equation used for acquiring each of the normalized scores.

$${\sum }_{i = 1}^{n} \frac{( {T}_{i} + 1 - {R}_{i , j} )}{{T}_{i}} \qquad [ Equation 1 ]$$

wherein i represents an i^{th} database, n represents the number of databases (for example, in FIG. 2, n is set to 6 because six databases are acquired using six prediction tools), Tᵢ represents the total number of miRNA-gene pairs in an i^{th} database, and represents a rank of j^{th} miRNA-gene pair in the i^{th} database.

For example, in the first database including 100 miRNA-gene pairs, when the miRNA1-gene1 pair is 20^{th} in the prediction score rank among the 100 miRNA1-gene1 pairs, standard score of the miRNA1-gene1 pair in the first database may be (100+1−20)/100=0.81. The control unit 140 sums standard scores of miRNA1-geng1 pairs in the 2^{nd} to n^{th} databases to calculate normalized scores of the miRNA1-gene1 pairs.

Next, the control unit 140 may determine the rank of miRNAs to a specific gene and the rank of genes to specific miRNA, based the normalized score (S330).

For example, assuming that there are miRNA1, miRNA3 and miRNA4 as miRNAs for being complementarily bound to genet, the control unit 140 may determine a rank of miRNAs according to complementary binding capacity to genet (that is, in rank of normalized score), based on respective normalized scores of gene1-miRNA1, gene1-miRNA3 and gene1-miRNA4. As shown in FIG. 2, because the normalized score between miRNA1-gene1 is set to 0.4 and the normalized score between miRNA3-gene1 is set to 0.6, with respect to the gene1, miRNA1 is second in rank and miRNA3 is third in rank.

The rank of genes with respect to specific miRNA can be determined by the method described above. For example, when genes that can complementarily bind to miRNA1 are gene1 and gene3, the control unit 140 may determine the rank of the genes according to force (level) of the complementary binding to the miRNA1 (that is, according to rank of normalized score) based on respective normalized scores of miRNA1-gene1 and miRNA1-gene3. As shown in FIG. 2, because the normalized score between miRNA1-gene1 is set to 0.4 and the normalized score between miRNA1-gene3 is set to 0.5, with respect to the miRNA1, gene1 is second in rank and gene3 is first in rank.

Then, the control unit 140 may calculate an interaction score between gene-miRNA based on the rank of genes and miRNAs (S340). Equation 2 provides an example of an equation used for calculating the interaction score.

$$( \frac{{t}_{mi} + 1 - {r}_{mi}}{{t}_{mi}} ) \times ( \frac{{t}_{gj} + 1 - {r}_{gj}}{{t}_{gj}} ) \qquad [ Equation 2 ]$$

wherein tₘᵢ represents the number of pairs between the i^{th} miRNA and genes (number of miRNAᵢ-gene), t_{gi} represents the number of pairs between the j^{th} gene and miRNAs (number of geneⱼ-miRNA), rₘᵢ represents a rank of normalized score of the i^{th} miRNA with respect to the j^{h} gene, and r_{gj} represents a rank of normalized score of the j^{th} gene with respect to the i^{th} miRNA.

Correlation Calculation

The target miRNA prediction tool as described above had no database associated with all human miRNAs and genes. In the present invention, interaction scores of various miRNAs and genes that cannot be predicted from the target miRNA prediction tool may be acquired using similarity between miRNAs, mutual influence between miRNAs, and transcription factors of genes.

### Example 1

### Calculation of Weight Based on Correlation

The computing device 100 according to the present invention may acquire correlation coefficients associated with expression patterns of specific miRNAs and specific genes obtained by microarray testing, and predict correlation coefficients between similar miRNAs similar to specific miRNAs and the specific genes. Calculation of correlation coefficients between similar miRNAs and specific genes will be described in detail with reference to the drawings described later.

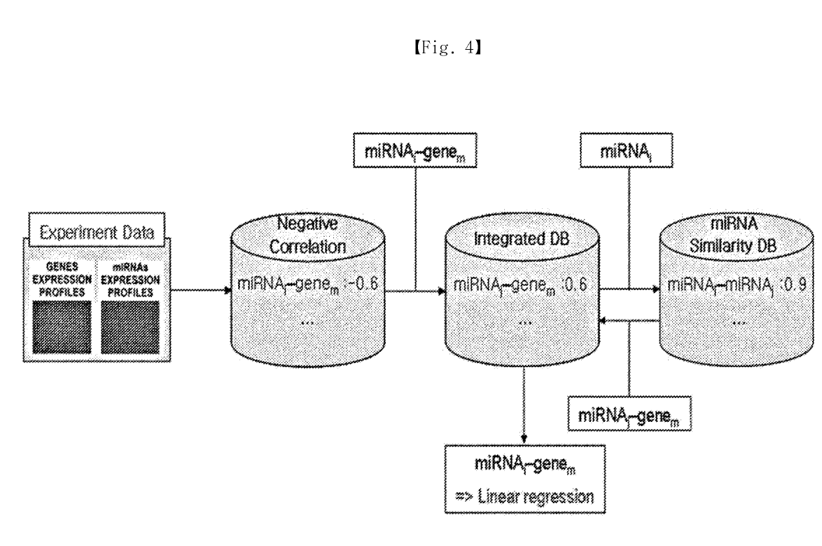

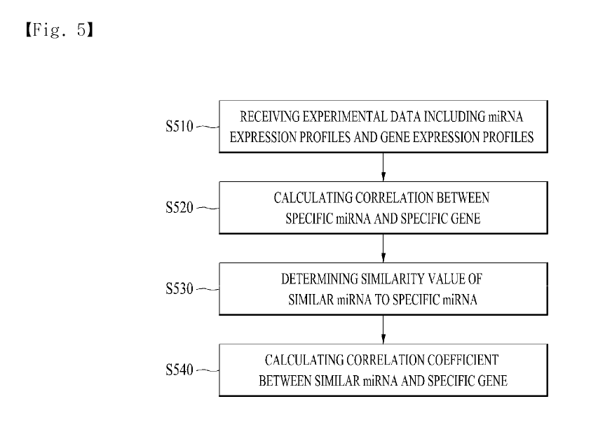

FIG. 4 is a conceptual view illustrating a method for calculating a correlation coefficient between similar miRNA and a specific gene using a similarity database, and FIG. 5 is a flowchart illustrating the calculation method of the correlation coefficient between similar miRNA and the specific gene using the similarity database.

First, upon inputting experimental data including gene expression profiles and miRNA expression profiles obtained by microarray testing (S510), the control unit 140 calculates correlation between a specific miRNA and a specific gene based on the input experimental data (S520).

Regarding the microarray testing, a gene microarray is a tool for measuring expression levels of the entirety or part of genes in organisms, which is called “DNA microarray.” The gene microarray expands observation of genes from a gene scale to the overall organisms, thus enabling research on an organism as a single system. In addition, the gene microarray is basically performed on a large scale by parallelizing conventional gene detection techniques and has brought about great change in data processing and analysis as well. The gene microarray was generally performed as follows. First, thousands to hundreds of thousands of gene sequences are immobilized on the surface of a slide having a size of about 1 cm², RNAs are extracted from cells collected under various experimental conditions, reverse-transcribed into DNAs and labeled with a fluorescent substance. Then, the labeled DNAs are hybridized with a microarray and are scanned to obtain an image, the intensities of fluorescence in gene sites by the fluorescent substance are measured using an image analysis program, whether or not genes are expressed is determined, and expression levels of genes are analyzed by comparison with quantified gene expression levels using informatics such as mathematics, statistics and computer engineering.

Through the microarray testing described above, expression levels of specific miRNAs and specific genes can be expressed numerically. The correlation between specific miRNA and a specific gene is a Pearson's correlation, which may indicate a ratio of an expression level variation of the specific miRNA with respect to an expression level increase of the specific gene.

Then, the computing device 100 may acquire a similarity value of similar miRNA to specific miRNA using a miRNA similarity database (S530). The miRNA similarity database may include a similarity value which numerically expresses functional similarity between miRNAs. The miRNA similarity database may be acquired by a BLAST or BLAT tool known in the art.

Then, the computing device 100 may calculate correlation between similar miRNA and a specific gene using the similarity value (S540). The calculation of the weight between similar miRNA and the gene may be carried out using a linear regression model using the similarity value.

### Example 2

### Calculation of Correlation in Consideration of Mutual Influence Between miRNAs

The computing device 100 according to the present invention may calculate a correlation coefficient between a specific gene and adjacent miRNA which forms a cluster with specific miRNA. The calculation of correlation in consideration of mutual influence between miRNAs will be understood from the description given later with reference to the drawings.

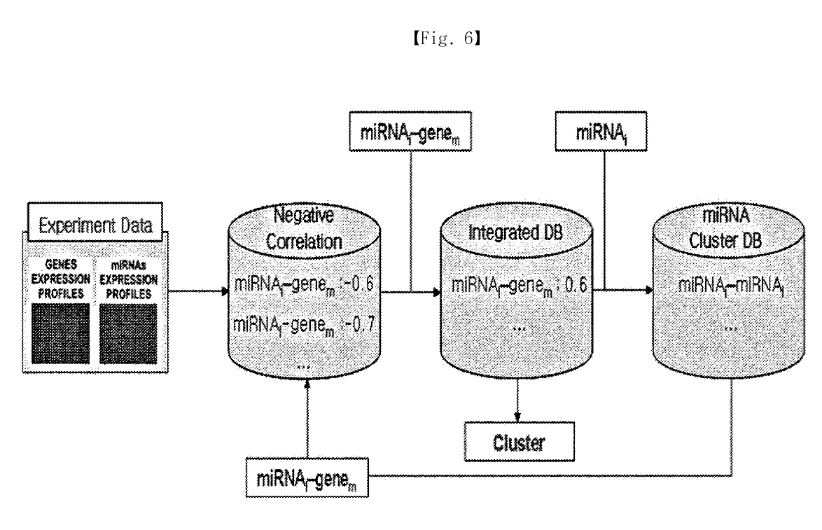

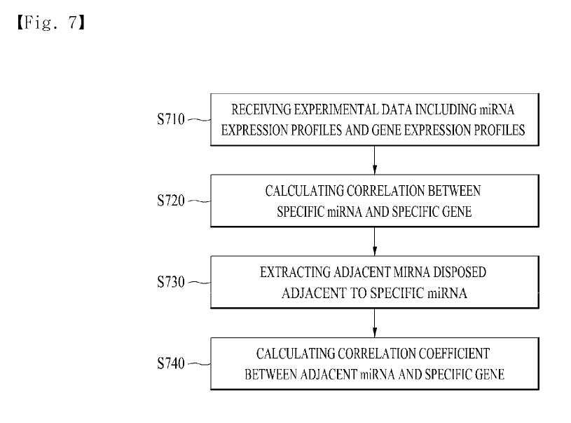

FIG. 6 is a conceptual view illustrating a method for calculating a correlation coefficient between adjacent miRNA and a specific gene using a miRNA cluster database, and FIG. 7 is a flowchart illustrating a method for calculating a weight between the adjacent miRNA and the specific gene using the miRNA cluster database.

First, upon inputting experimental data including gene expression profiles and miRNA expression profiles obtained by microarray testing (S710), the control unit 140 calculates correlation between specific miRNA and a specific gene based on the input experimental data (S720).

Then, the computing device 100 extracts adjacent miRNA, which is disposed within an effective distance from the specific miRNA input as experimental data, using a miRNA cluster database (S730). The miRNA cluster database includes distance data between miRNAs and enables the computing device 100 to determine that miRNA disposed within a distance of 10 kb (kilobase) from the specific miRNA is present within the effective distance. The effective distance is not necessarily limited to 10 kb and may be changed as needed.

Then, the computing device 100 may calculate a correlation coefficient between adjacent miRNA which is disposed within an effective distance from specific miRNA, and a gene (S740). For example, in an example as shown in FIG. 6, in a case in which miRNA₁ is adjacent miRNA of miRNAᵢ, the computing device 100 calculates a correlation coefficient of miRNA₁-geneₘ.

### Example 3

### Calculation of Correlation in Consideration of Transcription Factor

The computing device 100 according to the present invention calculates correlation coefficients in consideration of a transcription factor between genes. The calculation of correlation coefficients in consideration of the transcription factor between genes will be described with reference to the drawings given later.

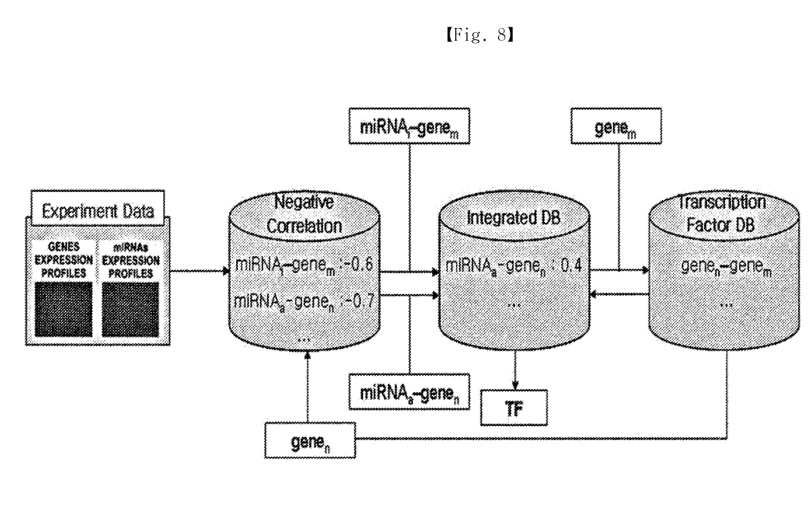

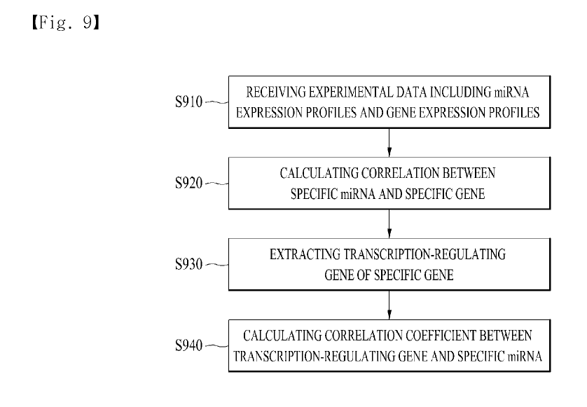

FIG. 8 is a conceptual view illustrating a method for calculating a correlation coefficient between specific miRNA and a transcription-regulating gene using a transcription factor database, and FIG. 9 is a flowchart illustrating the calculation method of the weight between specific miRNA and the transcription-regulating gene using the transcription factor database.

First, upon inputting experimental data including gene expression profiles and miRNA expression profiles obtained by microarray testing (S910), the control unit 140 may calculate correlation between specific miRNA and a specific gene based on the input experimental data (S920).

Then, the computing device 100 confirms presence of a transcription-regulating gene, which specifically binds to DNA base sequences of transcription regulation sites of specific genes, and activates or inhibits transcription of the specific genes, from the transcription factor database (S930).

When the transcription-regulating gene of specific gene is present, the computing device 100 calculates a correlation coefficient between the transcription-regulating gene and miRNA (S940). For example, in an example given in FIG. 8, in a case in which the transcription-regulating gene of the geneₘ, is geneₙ, the computing device 100 may calculate a correlation coefficient between miRNAₐ-geneₘ based on correlation coefficient between miRNAₐ-geneₙ.

The computing device 100 may calculate an interaction score between similar miRNA and a gene, an interaction score between adjacent miRNA and a gene and an interaction score between a transcription-regulating gene and miRNA based on the correlation coefficient calculated in Examples 1 to 3.

After the interaction score between miRNA-gene is obtained through a microRNA-targeting gene analysis algorithm, the computing device 100 extracts a biomarker for diagnosing pancreatic cancer using a specific expression gene list of a pancreatic cancer patient using a differentially-expressed gene analysis algorithm.

A method for extracting biomarkers for diagnosing pancreatic cancer based on the integrated analysis algorithm for biomarker extraction will be described in detail.

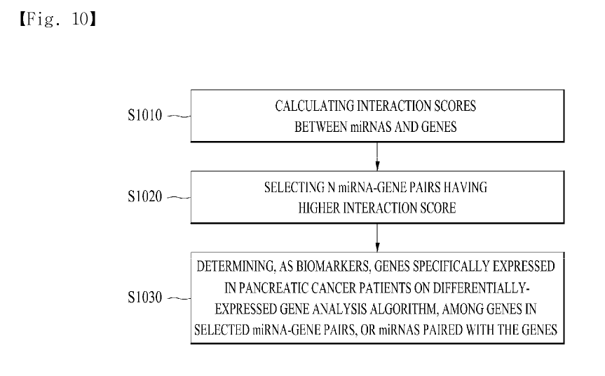

FIG. 10 is a flowchart illustrating a method for extracting a biomarker for diagnosing pancreatic cancer based on integrated analysis algorithm for biomarker extraction. For convenience of illustration, it is supposed that the computing device 100 stores a list of genes abnormally expressed (for example, over-expressed or under-expressed) in pancreatic cancer patients, unlike normal persons, using the differentially-expressed gene analysis algorithm.

Referring to FIG. 10, the computing device 100 calculates interaction scores between miRNAs-genes using microRNA-targeting gene analysis algorithm (S1010). The calculation of interaction scores has been described with reference to FIGS. 4 to 9 and a detailed explanation thereof is thus omitted.

Then, the computing device 100 selects n miRNA-gene pairs having a higher interaction score (S1020) and determines, as biomarkers for diagnosing pancreatic cancer, an intersection between genes in the selected miRNA-gene pairs and a list of genes specifically (abnormally) expressed in pancreatic cancer patients, unlike normal persons, or a set of miRNAs paired with the genes which belong to the intersection, using the differentially-expressed gene analysis algorithm (S1030). That is, genes having high interaction scores and being specifically expressed in pancreatic cancer patients, unlike normal persons, in differentially-expressed gene analysis algorithm, or miRNAs paired with the genes, may be determined as biomarkers for diagnosing pancreatic cancer.

In another example, the computing device 100 selects m genes according to higher rank of interaction scores of miRNA-gene pairs and determines an intersection of a list of genes abnormally expressed in pancreatic cancer patients, unlike normal persons, based on the differentially-expressed gene analysis algorithm, or miRNAs paired with the genes which belong to the intersection, as biomarkers for diagnosing pancreatic cancer.

ANO1, C19orf33, EIF4E2, FAM108C1, IL1B, ITGA2, KLF5, LAMB3, MLPH, MMP11, MSLN, SFN, SOX4, TMPRSS4, TRIM29 and TSPAN1 may be determined as biomarkers for diagnosing pancreatic cancer, when n genes in miRNA-gene pairs having a higher interaction score (wherein q-value is equal to or lower than 0.05 and correlation coefficient is equal to or lower than −0.5) are selected using six miRNA prediction tools, i.e., Targetscan, miRDB, DIANA-microT, PITA, miRanda and MicroCosm.

Characteristics of the respective biomarkers are as follows:

ANO1 (anoctamin 1, calcium activated chloride channel) serves as a calcium-activated chloride channel.

C19orf33 (chromosome 19 open reading frame 33) is a gene on the 19^{th} human chromosome and functions thereof are not known yet.

EIF4E2 (eukaryotic translation initiation factor 4E family member 2) recognizes and binds the 7-methylguanosine-containing mRNA cap during an early step in the initiation of protein synthesis and facilitates ribosome binding by inducing the unwinding of the mRNAs secondary structures.

FAM108C1 (family with sequence similarity 108, member C1) has serine type peptidase activity and hydrolase activity.

IL1B (interleukin 1, beta) is produced by activated macrophages and IL-1 induces release of IL-2, aging and proliferation of B-cells, and activity of fibroblast growth factors and thereby stimulates thymocyte proliferation. IL-1 proteins are reported to be involved in inflammatory response, to be confirmed to be endogenous pyrogens and to stimulate release of prostaglandin and procollagenase from synovial cells.

ITGA2 (integrin, alpha 2 (CD49B, alpha 2 subunit of VLA-2 receptor)) is integrin alpha-2/beta-1 which is a receptor for laminin, collagen, collagen C-propeptides, fibronectin and E-cadherin. ITGA2 recognizes the proline-hydroxylated sequence G-F-P-G-E-R in collagen. ITGA2 is responsible for adhesion of platelets and other cells to collagens, modulation of collagen and collagenase gene expression, force generation and organization of newly synthesized extracellular matrix.

KLF5 (kruppel-like factor 5(intestinal)) is a transcription factor that binds to GC box promoter elements, which activates transcription of these genes.

LAMB3 (laminin, beta 3) binds to cells via a high-affinity receptor, and laminin is considered to mediate the attachment, migration and organization of cells into tissues during embryonic development by interacting with other extracellular matrix components.

MLPH (melanophilin) is a Rab effector protein that mediates melanosome transportation.

MMP11 (matrix metallopeptidase 11(stromelysin 3)) has an important role in propagation of epithelial malignancy.

Membrane-anchored forms of MSLN (mesothelin) may have a role in cellular adhesion.

SFN (stratifin) is 1) a p53-regulated inhibitor of G2/M progression and 2) an adapter protein implicated in the regulation of a large spectrum of both general and specialized signaling pathways. SFN binds to a large number of partners, usually by recognition of a phosphoserine or phosphothreonine motif. The binding generally results in modulation of the activity of the binding partner. When bound to KRT17, SFN regulates protein synthesis and epithelial cell growth by stimulating Akt/mTOR pathway.

SOX4 (SRY (sex determining region Y)-box is a transcriptional activator that binds with high affinity to the T-cell enhancer motif, 5′-AACAAAG-3′ motif.

TMPRSS4 (transmembrane protease, serine 4) is a protein protease and is considered to activate ENaC.

TRIM29 (tripartite motif-containing 29) reduces radiosensitivity defects of ataxia telangiectasia (AT) fibroblast cell lines.

TSPAN1 (tetraspanin 1) mediates signaling events functioning to regulate cell development, activation, growth and migration.

Meanwhile, upon using six miRNA prediction tools, i.e., Targetscan, miRDB, DIANA-microT, PITA, miRanda and MicroCosm and using tissues as biological samples, a set of miRNAs paired with n genes in miRNA-gene pairs having a high interaction score (wherein q-value is equal to or lower than 0.05 and correlation coefficient is equal to or lower than −0.5), i.e., hsa-let-7g-3p, hsa-miR-7-2-3p, hsa-miR-23a-5p, hsa-miR-27a-5p, hsa-miR-92a-1-5p, hsa-miR-92a-2-5p, hsa-miR-122-5p, hsa-miR-154-3 p, hsa-miR-183-5p, hsa-miR-204-5p, hsa-miR-208b-3p, hsa-miR-425-5p, hsa-miR-510-5p, hsa-miR-520a-5p, hsa-miR-552-3p, hsa-miR-553, hsa-miR-557, hsa-miR-608, hsa-miR-611, hsa-miR-612, hsa-miR-671-5p, hsa-miR-1200, hsa-miR-1275, hsa-miR-1276 and hsa-miR-1287-5p, may be determined as biomarkers for diagnosing pancreatic cancer.

In addition, when blood is used as a biological sample, hsa-miR-27a-5p, hsa-miR-183-5 p and hsa-miR-425-5p are determined as biomarkers for diagnosing pancreatic cancer.

Base sequences of respective miRNAs that belong to the biomarkers are shown in the following Table 2.

TABLE 2

| Mature_id | miRNA_id | Sequence |
|---|---|---|
| hsa-let-7g-3p | hsa-let-7g | CUGUACAGGCCACUGCCUUGC |
| hsa-miR-7-2-3p | hsa-mir-7-2 | CAACAAAUCCCAGUCUACCUAA |
| hsa-miR-23a-5p | hsa-mir-23a | GGGGUUCCUGGGGAUGGGAUUU |
| hsa-miR-27a-5p | hsa-mir-27a | AGGGCUUAGCUGCUUGUGAGCA |
| hsa-miR-92a-1- | hsa-mir-92a- | AGGUUGGGAUCGGUUGCAAUGCU |
| 5p | 1 | |
| hsa-miR-92a-2- | hsa-mir-92a- | GGGUGGGGAUUUGUUGCAUUAC |
| 5p | 2 | |
| hsa-miR-122-5p | hsa-mir-122 | UGGAGUGUGACAAUGGUGUUUG |
| hsa-miR-154-3p | hsa-mir-154 | AAUCAUACACGGUUGACCUAUU |
| hsa-miR-183-5p | hsa-mir-183 | UAUGGCACUGGUAGAAUUCACU |
| hsa-miR-204-5p | hsa-mir-204 | UUCCCUUUGUCAUCCUAUGCCU |
| hsa-miR-208b- | hsa-mir-208b | AUAAGACGAACAAAAGGUUUGU |
| 3p | | |
| hsa-miR-425-5p | hsa-mir-425 | AAUGACACGAUCACUCCCGUUGA |
| hsa-miR-510-5p | hsa-mir-510 | UACUCAGGAGAGUGGCAAUCAC |
| hsa-miR-520a- | hsa-mir-520a | CUCCAGAGGGAAGUACUUUCU |
| 5p | | |
| hsa-miR-552-3p | hsa-mir-552 | AACAGGUGACUGGUUAGACAA |
| hsa-miR-553 | hsa-mir-553 | AAAACGGUGAGAUUUUGUUUU |
| hsa-miR-557 | hsa-mir-557 | GUUUGCACGGGUGGGCCUUGUCU |
| hsa-miR-608 | hsa-mir-608 | AGGGGUGGUGUUGGGACAGCUCC |
| | | GU |
| hsa-miR-611 | hsa-mir-611 | GCGAGGACCCCUCGGGGUCUGAC |
| hsa-miR-612 | hsa-mir-612 | GCUGGGCAGGGCUUCUGAGCUCC |
| | | UU |
| hsa-miR-671-5p | hsa-mir-671 | AGGAAGCCCUGGAGGGGCUGGAG |
| hsa-miR-1200 | hsa-mir-1200 | CUCCUGAGCCAUUCUGAGCCUC |
| hsa-miR-1275 | hsa-mir-1275 | GUGGGGGAGAGGCUGUC |
| hsa-miR-1276 | hsa-mir-1276 | UAAAGAGCCCUGUGGAGACA |
| hsa-miR-1287- | hsa-mir-1287 | UGCUGGAUCAGUGGUUCGAGUC |
| 5p | | |

Verification testing on biomarkers for diagnosing pancreatic cancer acquired from the results and results thereof will be described in detail.

Pancreatic Cancer Patient Sample and Microarray Testing

All tests were performed under approval of the Institutional Review Board, the University of California Los Angeles (UCLA), US. Three independent and non-common patient groups were used for this study. Start test groups of samples obtained from 42 pancreatic cancer patients snap frozen during surgery and 7 normal persons were used for microarray. Of these, only samples containing 30% or more of tumor cells were selected for multi-platform analysis (n=25) determined by representative hematoxylin and eosin (H&E) selection by practicing gastrointestinal pathologist (DWD). The second group of patients (n=42) is isolated from formalin fixed paraffin-embedded (FFPE) tissue blocks and is a tumor used as an identification group for quantitative PCR (qPCR). A data set of the third group of patients (n=148) is a tissue microarray (TMA) tumor used as an identification group for immunohistochemistry (IHC, immunohistochemistry). All clinical pathology and survival information for respective patient groups were extracted from UCLA surgery database of pancreatic patients maintained afterward. Disease prevalence was judged based on biopsy, radiologic evidence or death. Electronic medical records are used to determine both related clinical and pathological features, and unrelated disease (disease-free) survival and disease-specific survival (DSS). A survey of social security death index was used for determining the overall survival. Survival analysis of tissue microarray (TMA) groups was limited to the overall survival. The overall times of disease-free and disease-specific survival were investigated on identification groups for microarray and qPCR. Survival interval is determined from the date of surgery to the date of death or the last contact of the patient (Clinical Cancer Research, Vol. 18, No. 5, 1352-1363.).

Verification of Biomarker Set of the Present Invention

Verification of diagnosis of pancreatic cancer using gene biomarker sets of the present invention was targeted for 84 pancreatic cancer patients and 84 normal persons, i.e., 168 subjects in total. Verification was performed by principal component analysis and hierarchical clustering (euclidean distance, complete method) analysis using gene expression omnibus (GEO) data GSE28735 and GSE15471, using blood harvested from the subjects.

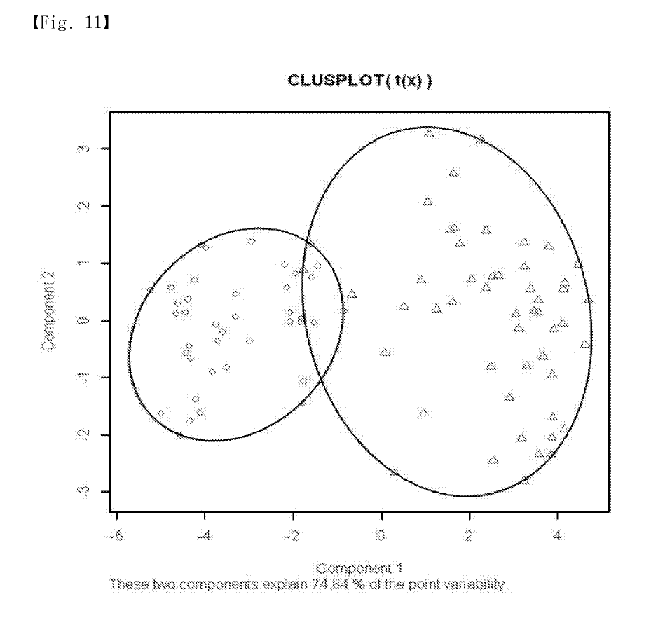

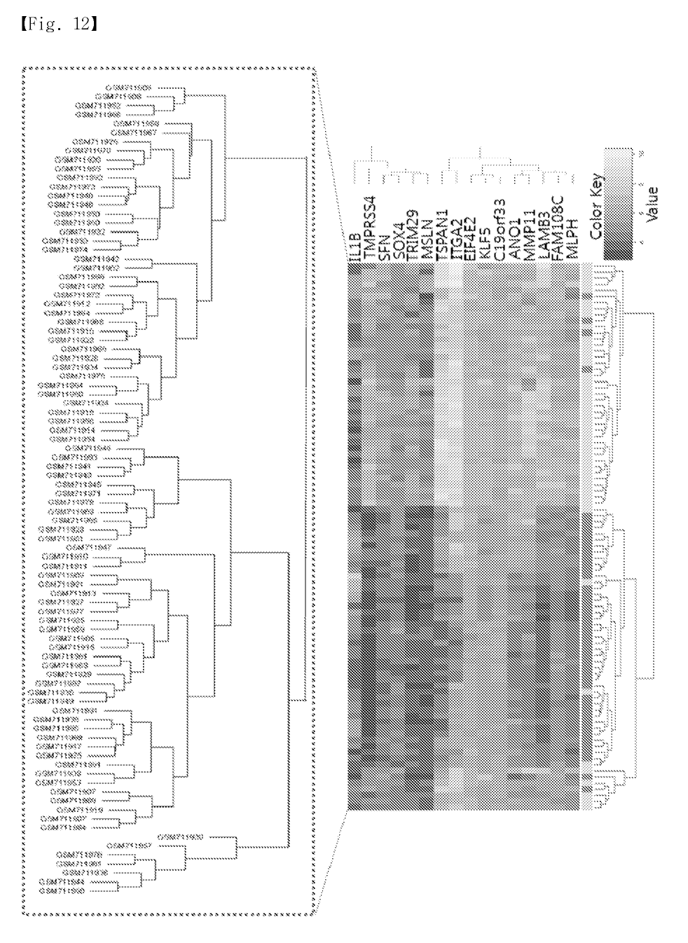

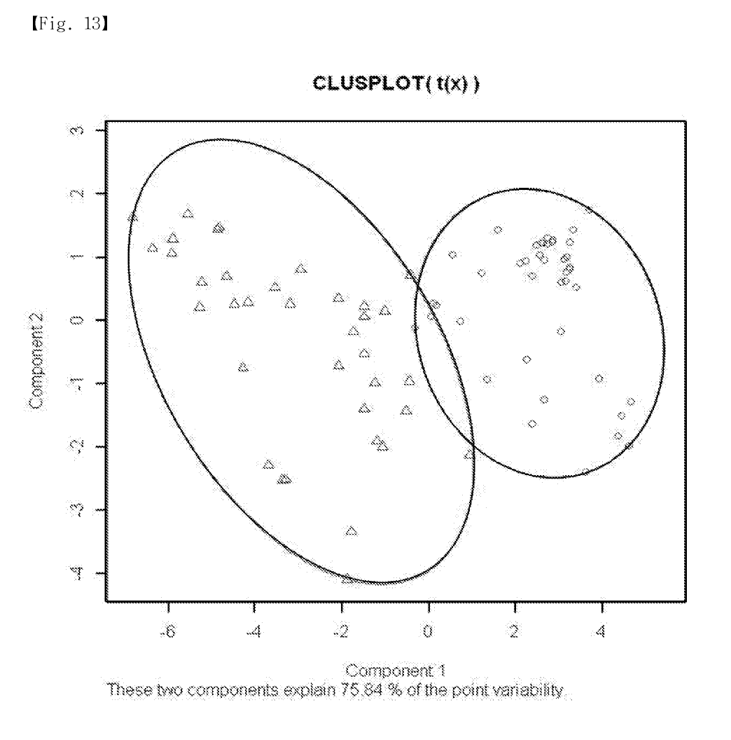

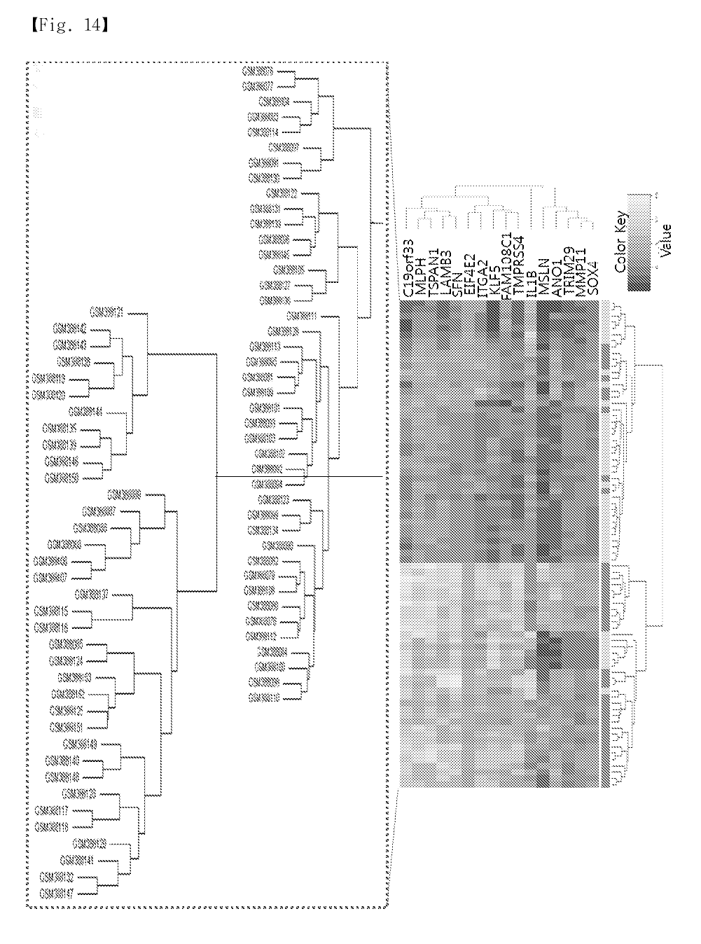

As a result, sensitivity to pancreatic cancer was 83% (70/84) and specificity thereto was 81% (68/84). FIGS. 11 and 12 are a cluster plot showing results of principal component analysis using data GSE28735 and a heat map showing results of hierarchical clustering analysis using data GSE28735, respectively, and FIGS. 13 and 14 are a cluster plot showing results of principal component analysis using data GSE15471 and a heat map showing results of hierarchical clustering analysis using data GSE15471, respectively. In FIGS. 11 and 13, component 1 in a horizontal axis represents a first principal component (PC 1) and component 2 in a vertical axis represents a second principal component (PC 2). Furthermore, an object represented by a triangle represents a cancer patient and an object represented by a circle represents a normal person. In FIGS. 12 and 14, a red bar and a blue bar disposed in an upper part in the heat map represent a cancer patient and a normal person, respectively.

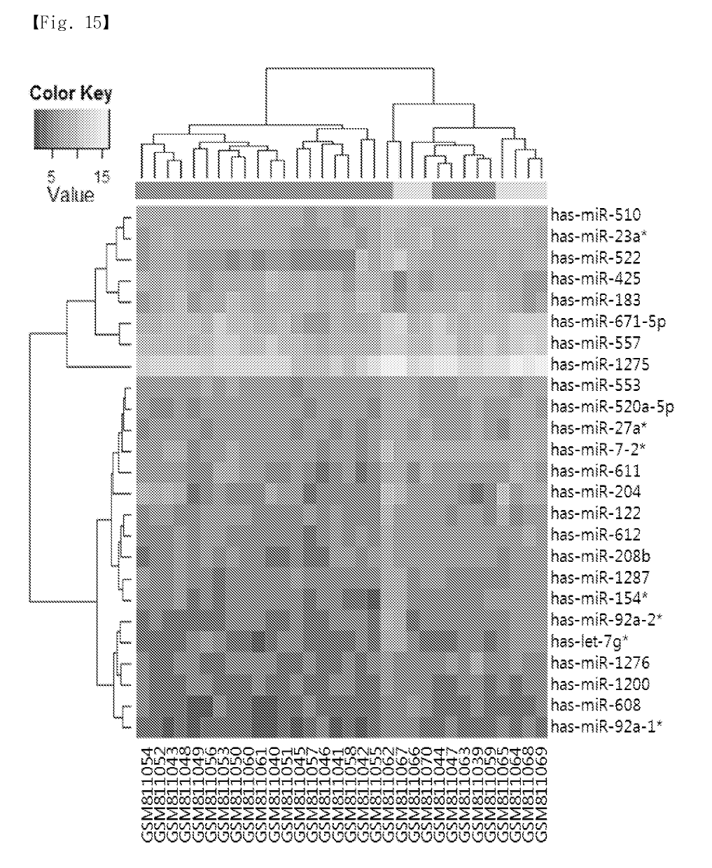

Meanwhile, verification of pancreatic cancer diagnosis using microRNA biomarkers for tissue samples of the present invention was targeted for 25 pancreatic cancer patients and 7 normal persons, i.e., 32 subjects in total. Verification was performed by principal component analysis and hierarchical clustering (euclidean distance, complete method) analysis using gene expression omnibus (GEO) data GSE32678, using samples obtained from the subjects. As a result, sensitivity to pancreatic cancer was 80% (20/25) and specificity thereto was 100% (7/7). FIG. 15 is a view illustrating results of hierarchical clustering analysis using data GSE32678.

Verification of pancreatic cancer diagnosis using microRNA biomarkers for blood samples of the present invention was targeted for 17 pancreatic cancer patients and 2 normal persons, i.e., 19 subjects in total. Verification was performed by principal component analysis and hierarchical clustering (euclidean distance, complete method) analysis using small RNA sequencing data, which is a next generation sequencing (NGS) method, using samples obtained from the subjects.

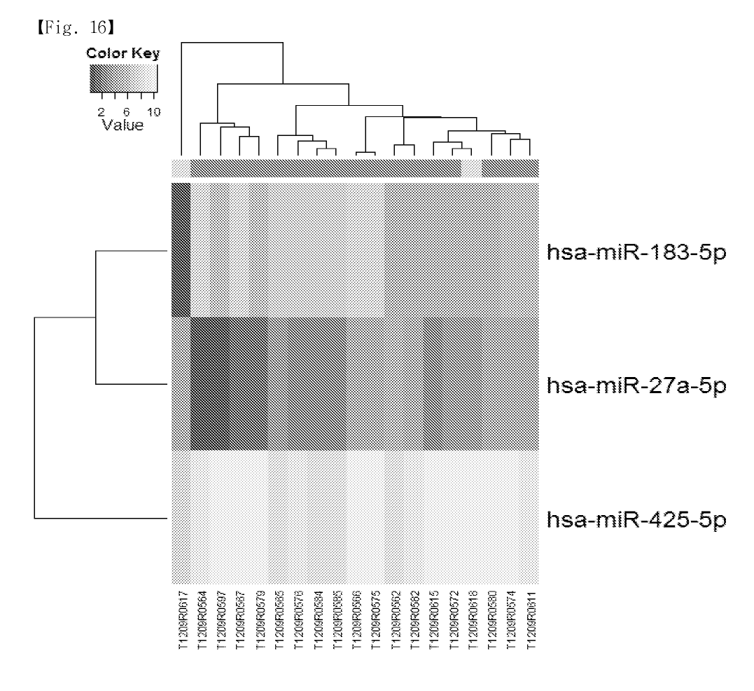

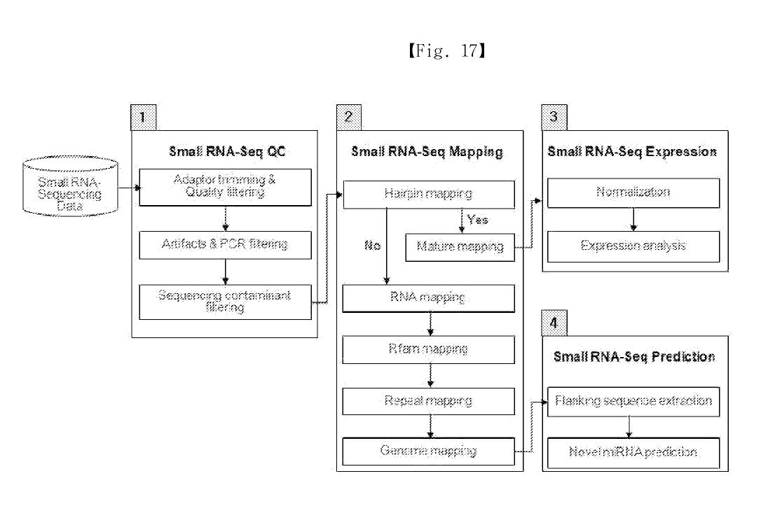

A general description of the small RNA sequencing data analysis is provided in FIG. 17. As a result, sensitivity to pancreatic cancer was 100% (17/17) and specificity thereto was 50% (1/2). FIG. 16 is a view illustrating results of hierarchical clustering analysis using the small RNA sequencing data. In FIGS. 14 and 15, a red bar and a blue bar disposed in an upper part in the heat map represent a cancer patient and a normal person, respectively.

Meanwhile, the biomarker is used as a device for diagnosing pancreatic cancer. Examples of the device for diagnosing pancreatic cancer include diagnosis chips, diagnosis kits, quantitative PCR (qPCR) apparatuses, point-of-care test (POCT) apparatuses, sequencers and the like. Configurations and elements of diagnosis chips, diagnosis kits, quantitative PCR (qPCR) equipment, point-of-care test (POCT) equipment and sequencers, excluding biomarker sets, may be selected from those well-known in the art.

Meanwhile, the methods according to embodiments of the present invention can be implemented in processor-readable codes in a processor-readable recording medium. Examples of the processor-readable recording medium include includes ROMs, RAMs, CD-ROMs, magnetic tapes, floppy disks, optical data storage devices and the like, and devices implemented in the form of carrier waves, for example, transmission via the internet.

Configurations and methods of the embodiments described above may be limitedly applied to the computing device 100 described above and selective combination of the entirety or part of the respective embodiments may be applied thereto such that various modifications of the embodiments are possible.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for extracting a biomarker for diagnosing pancreatic cancer comprising:
calculating interaction scores numerically expressing complementary binding capacity between microRNAs and genes;
determining n microRNA-gene pairs, each having a higher interaction score among the interaction scores; and
extracting a gene in common with a gene specifically expressed in a pancreatic cancer patient or microRNA paired with the gene from the n microRNA-gene pairs.

2. The method according to claim 1, wherein the calculating comprises:
acquiring one or more databases statistically obtained from prediction scores between microRNAs and genes;
calculating normalized scores from the prediction scores between microRNAs and genes;
calculating a binding rank of microRNAs to each gene and a binding rank of genes to each microRNA, based on the normalized scores; and
calculating the interaction scores based on the binding rank of microRNAs and the binding rank of genes.

3. The method according to claim 2, wherein the databases are produced using a microRNA target prediction tool.

4. The method according to claim 3, wherein the microRNA target prediction tool comprises at least one of Targetscan, miRDB, DIANA-microT, PITA, miRanda MicroCosm, RNAhybrid, PicTar and RNA22.

5. The method according to claim 2, wherein each of the normalized scores is calculated based on a rank of the prediction scores of the microRNA-gene pairs in the databases.

6. The method according to claim 5, wherein the normalized score is calculated in accordance with the following Equation 1:
$${\sum }_{i = 1}^{n} \frac{( {T}_{i} + 1 - {R}_{i , j} )}{{T}_{i}} \qquad [ Equation 1 ]$$
wherein i represents an i^{th} database, n represents the number of databases, Tᵢ represents the total number of miRNA-gene pairs in the i^{th} database, and R_{i,j} represents a prediction score rank of a j^{th} miRNA-gene pair in the i^{th} database.

7. The method according to claim 5, wherein each of the interaction scores is calculated based on rank of microRNAs to each gene and rank of genes to each microRNA based on the normalized score.

8. The method according to claim 7, wherein the interaction score is calculated in accordance with the following Equation 2:
$$( \frac{{t}_{mi} + 1 - {r}_{mi}}{{t}_{mi}} ) \times ( \frac{{t}_{gj} + 1 - {r}_{gj}}{{t}_{gj}} ) \qquad [ Equation 2 ]$$
wherein tₘᵢ represents the number of pairs between an i^{th} miRNA and genes (number of miRNAᵢ-gene), t_{gj} represents the number of pairs between a i^{th} gene and miRNAs (number of geneⱼ-miRNA), rₘᵢ represents a normalized score rank of the i^{th} miRNA to the j^{th} gene, and r_{gj} represents a normalized score rank of the j^{th} gene to the i^{th} miRNA.

9. A computing device comprising:
a memory unit for storing data; and
a control unit for performing a calculation operation,
wherein the control unit calculates interaction scores numerically expressing complementary binding capacity between microRNAs and genes, determines n microRNA-gene pairs, each having a higher interaction score among the interaction scores and extracts a gene in common with a gene specifically expressed in a pancreatic cancer patient or microRNA paired with the gene from the n microRNA-gene pairs.

10. A biomarker for diagnosing pancreatic cancer comprising ANO1, C19orf33, EIF4E2, FAM108C1, IL1B, ITGA2, KLF5, LAMB3, MLPH, MMP11, MSLN, SFN, SOX4, TMPRSS4, TRIM29 and TSPAN1.

11. A biomarker for diagnosing pancreatic cancer using tissue as a biological sample, the biomarker comprising hsa-let-7g-3p, hsa-miR-7-2-3p, hsa-miR-23a-5p, hsa-miR-27a-5p, hsa-miR-92a-1-5p, hsa-miR-92a-2-5p, hsa-miR-122-5p, hsa-miR-154-3p, hsa-miR-183-5p, hsa-miR-204-5p, hsa-miR-208b-3p, hsa-miR-425-5p, hsa-miR-510-5p, hsa-miR-520 a-5p, hsa-miR-552-3p, hsa-miR-553, hsa-miR-557, hsa-miR-608, hsa-miR-611, hsa-miR-612, hsa-miR-671-5p, hsa-miR-1200, hsa-miR-1275, hsa-miR-1276, and hsa-miR-1287-5p.

12. A biomarker for diagnosing pancreatic cancer using blood as a biological sample, the biomarker comprising hsa-miR-27a-5p, hsa-miR-183-5p, and hsa-miR-425-5p.

13. A device for diagnosing pancreatic cancer comprising the biomarker comprising ANO1, C19orf33, EIF4E2, FAM108C1, IL1B, ITGA2, KLF5, LAMB3, MLPH, MMP11, MSLN, SFN, SOX4, TMPRSS4, TRIM29 and TSPAN1.

14. The device according to claim 13, wherein the device comprises a diagnosis chip, a diagnosis kit, a quantitative PCR (qPCR) apparatus, a point-of-care test (POCT) apparatus or a sequencer.
